(19) United States
(12) Patent Application Publication
(10) Pub. No.: US 2019/0201987 A1
(43) Pub. Date: Jul. 4, 2019

(54) BIT ADAPTER

(71) Applicant: Kwon J. PARK, Diamond Bar, CA (US)

(72) Inventor: Kwon J. PARK, Diamond Bar, CA (US)

(21) Appl. No.: 15/859,486

(22) Filed: Dec. 30, 2017

(51) Int. Cl. B23B 51/12; B25D 17/08

(52) U.S. Cl. CPC B23B 51/12; B25D 2250/051; B25D 17/08

(57) ABSTRACT

A bit adapter is provided, which includes a bit-installing portion, a middle portion, and a shank portion. The bit-installing portion has a hexagonal socket hole for receiving a drill tip of a first size. The middle portion is extended from a rear portion of the front chuck portion for a specific length. The shank portion is extended from a rear portion of the middle portion and having a hexagonal cross-section of a second size. The shank portion is configured to be received by a drill. A bit adapter set with four different sizes of bit adapters enables a user to have a flexibility to choose drills and drill bits. A three-piece bit adapter increases the flexibility still further.

### BACKGROUND OF THE INVENTION

The present invention relates to a bit adapter.

There are many manufacturers of drills and drill bits on the market. However, since their available sizes are somewhat different from one another, sometimes it may be inconvenient or very challenging for the user to mix and use the drills and drill bits of different manufacturers.

Accordingly, a need for a bit adapter has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a bit adapter.

An aspect of the invention provides a bit adapter comprising a bit-installing portion, a middle portion, and a shank portion.

The bit-installing portion has a hexagonal socket hole for receiving a drill tip of a first size.

The middle portion is extended from a rear portion of the front chuck portion for a specific length.

The shank portion is extended from a rear portion of the middle portion and having a hexagonal cross-section of a second size.

The shank portion is configured to be received by a drill.

The first size may be equal to the second size.

The first size may be different from the second size.

The bit-installing portion, the middle portion, and the shank portion may be formed integrally.

The shank portion may be heat-treated.

The first size may comprise one out of ¼″, ⅜″, and 7/16″. The second size may comprise one of 7/16″ and ¼″.

In an embodiment, the first size may be ¼″ and the second size may be 7/16″.

In another embodiment, the first size may be ⅜″ and the second size may be 7/16″.

In still another embodiment, the first size may be ⅜″ and the second size may be ¼″.

In still another embodiment, the first size is 7/16″ and the second size is ¼″.

A length of the shank portion may have a range from about 2½″ to about 24″.

The drill may comprise an impact drill.

Another aspect of the invention, a bit adapter set comprising a first bit adapter, a second bit adapter, a third bit adapter, and a fourth bit adapter.

Each of the first to fourth bit adapter comprises a bit-installing portion having a hexagonal socket hole for receiving a drill tip of a first size, a middle portion extended from a rear portion of the front chuck portion for a specific length, and a shank portion extended from a rear portion of the middle portion and having a hexagonal cross-section of a second size. The shank portion is configured to be received by a drill.

The first bit adapter has the first size of ¼″ and the second size of 7/16″, the first bit adapter has the first size of ⅜″ and the second size of 7/16″, the first bit adapter has the first size of ⅜″ and the second size of ¼″, and the first bit adapter has the first size of 7/16″ and the second size of ¼″. The first to fourth bit adapters are configured to accommodate the drills and drill bits of different kinds.

The shank portion of each of the first to fourth bit adapters may be heat-treated.

Still another aspect of the invention provides a three-piece bit adapter comprising a bit-installing portion, a shank portion, and a connector portion.

The bit-installing portion has a hexagonal socket hole at a front end for receiving a drill tip of a first size and a first connecting portion at a rear end.

The shank portion has a second connecting portion at a front end and a hexagonal cross-section of a second size at a rear end, which is configured to be received by a drill.

The connector portion has a third connecting portion corresponding to the first connecting portion at a front end and a fourth connecting portion corresponding to the second connecting portion at a rear end.

The shank portion may be heat-treated.

The connector portion may be heat-treated.

The first connecting portion and the third connecting portion may comprise a male fastening device and a female fastening device.

The second connecting portion and the fourth connecting portion may comprise a male fastening device and a female fastening device.

The advantages of the present invention are: (1) the bit adapters and their set according to the invention gives a flexibility to choose drills and drill bits of different manufacturers; and (2) the three-piece bit adapter according to the invention impart still further flexibility to the user in combining and using the drills and drill bits.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a bit adapter installed on a drill;

FIG. 2 is a perspective view showing a bit adapter according to an embodiment of the invention;

FIG. 3 is a perspective view showing a bit adapter according to another embodiment of the invention;

FIG. 4 is a perspective view showing a bit adapter according to still another embodiment of the invention;

FIG. 5 is another perspective view showing the bit adapter in FIG. 4;

FIG. 6 is a perspective view showing a bit adapter according to another embodiment of the invention;

FIG. 7 is another perspective view showing the bit adapter in FIG. 6;

FIG. 8 is a perspective view showing bit adapters with different lengths according to still another embodiment of the invention;

FIG. 9 shows two exemplary drill bits and a set of four bit adapters according to embodiments of the invention; and

FIG. 10 shows a connector portion for connecting a bit-installing portion and a shank portion according to still another embodiment of the invention.

### DETAILED DESCRIPTION EMBODIMENTS OF THE INVENTION

Referring to the figures, the embodiments of the invention are described in detail.

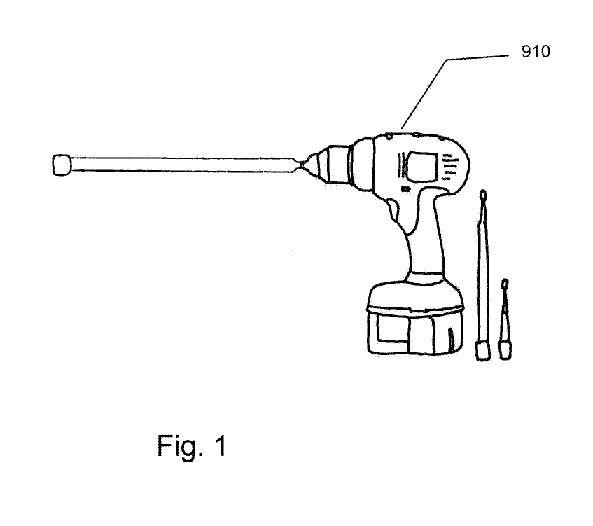

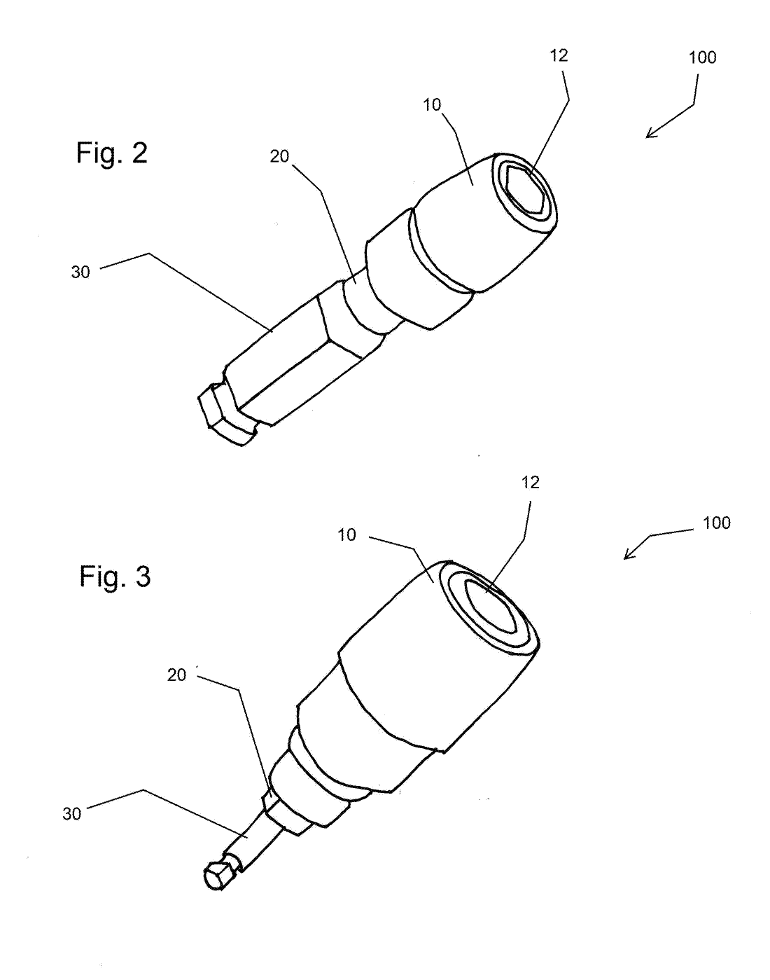

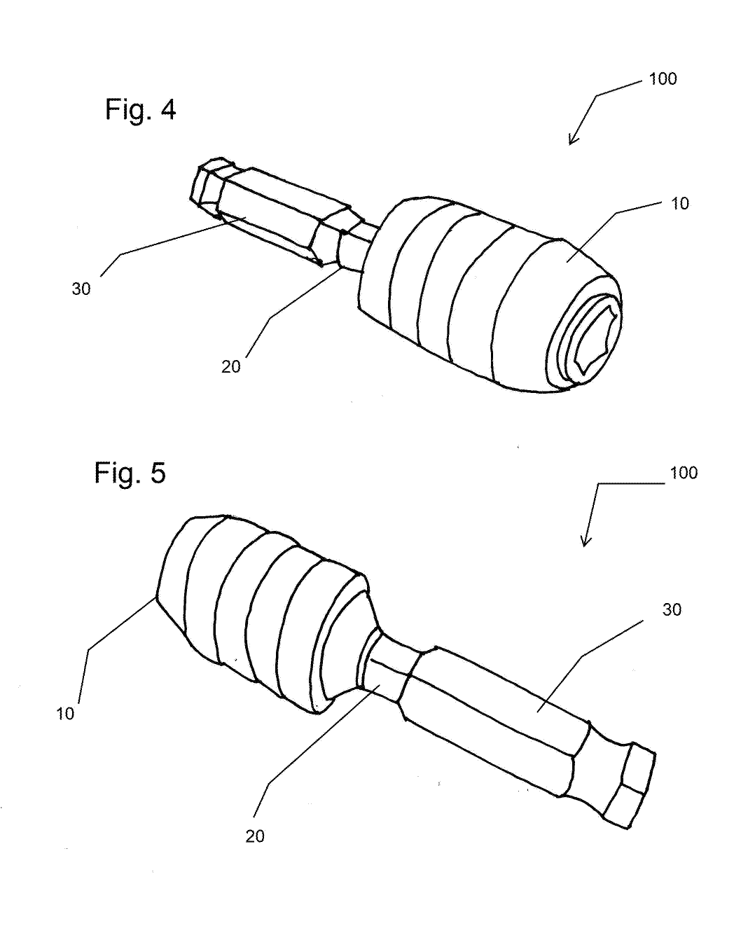

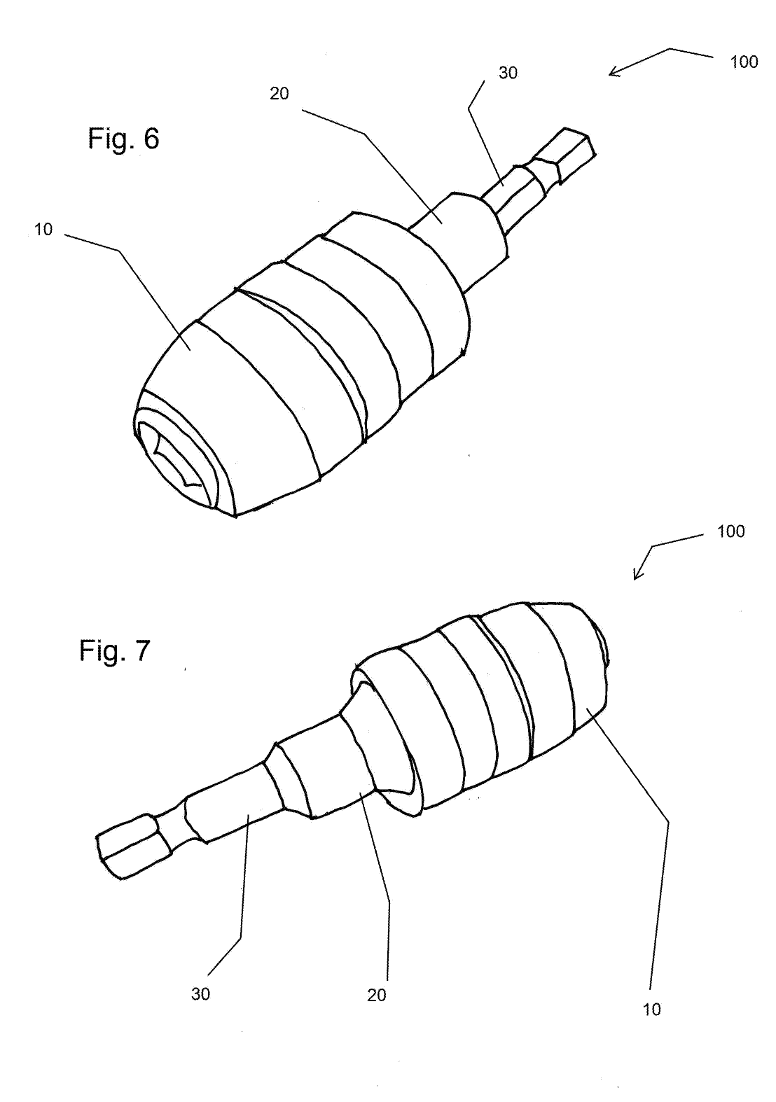

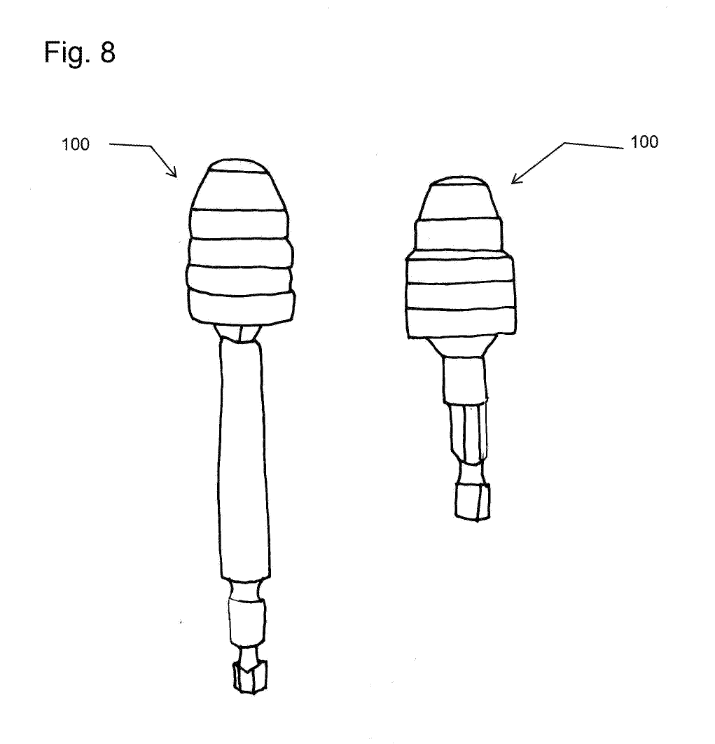

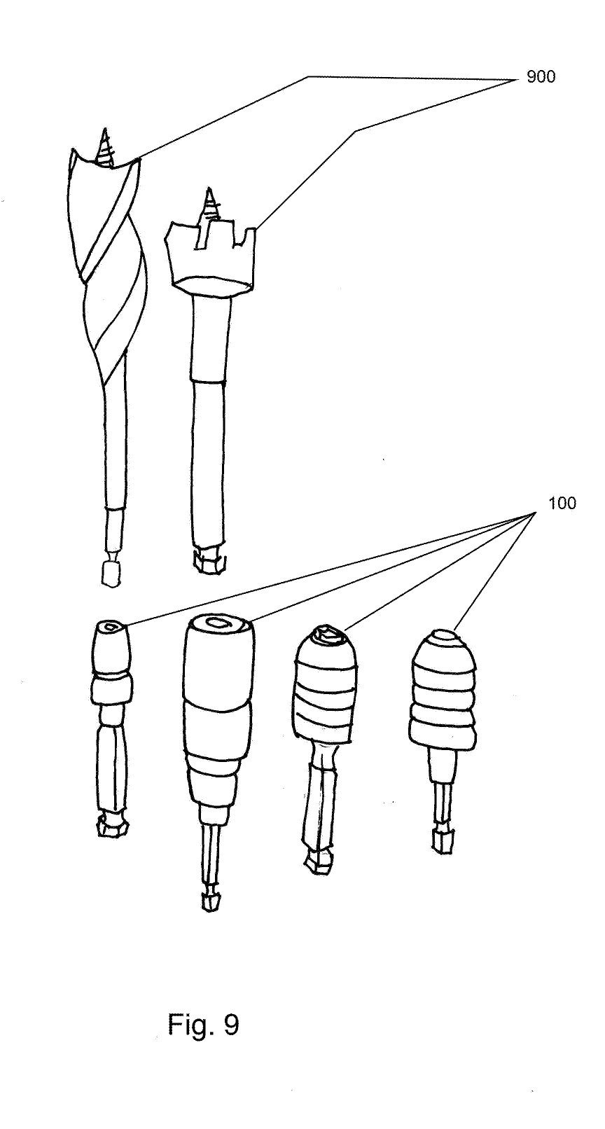

FIG. 1 shows a general idea of bit adapter and a drill. FIGS. 2-8 show bit adapters according to embodiments of the invention. FIG. 9 shows drill bits and a set of bit adapters according to embodiments of the invention. FIG. 10 shows a connector portion for a three-piece bit adapter according to still another embodiment of the invention.

An aspect of the invention provides a bit adapter (100) comprising a bit-installing portion (10), a middle portion (20), and a shank portion (30) as shown in FIGS. 2 through 8.

The bit-installing portion (10) has a hexagonal socket hole (12) for receiving a drill tip (900) of a first size as shown in FIGS. 2 and 3.

The middle portion (20) is extended from a rear portion of the bit-installing portion (10) or the front chuck portion by a specific length.

The shank portion (30) is extended from a rear portion of the middle portion (20) and having a hexagonal cross-section of a second size as shown in FIGS. 2-8.

The shank portion (30) is configured to be received by a drill (910).

The first size may be equal to the second size.

Alternatively, the first size may be different from the second size.

The bit-installing portion (10), the middle portion (20), and the shank portion (30) may be formed integrally.

The shank portion (30) may be heat-treated, which hardens the shank portion (30) to which an exceptionally strong force may be applied by the drill (910).

The first size may comprise one out of ¼″, ⅜″, and 7/16″. The second size may comprise one of 7/16″ and ¼″.

In an embodiment, the first size may be ¼″ and the second size may be 7/16″.

In another embodiment, the first size may be ⅜″ and the second size may be 7/16″.

In still another embodiment, the first size may be ⅜″ and the second size may be ¼″.

In still another embodiment, the first size may be 7/16″ and the second size is ¼″.

A length of the shank portion may have a range from about 2½″ to about 24″.

The drill (910) may comprise an impact drill.

Another aspect of the invention, a bit adapter set comprising a first adapter, a second adapter, a third adapter, and a fourth adapter as shown in a lower portion of FIG. 9.

Each of the first to fourth adapter (100) comprises a bit-installing portion (10) having a hexagonal socket hole (12) for receiving a drill tip (900) of a first size, a middle portion (20) extended from a rear portion of the bit-installing portion (10) or the front chuck portion by a specific length, and a shank portion (30) extended from a rear portion of the middle portion (20) and having a hexagonal cross-section of a second size. The shank portion (300 is configured to be received by a drill.

The first adapter (100) has the first size of ¼″ and the second size of 7/16″, the second adapter (100) has the first size of ⅜″ and the second size of 7/16″, the third adapter (100) has the first size of ⅜″ and the second size of ¼″, and the fourth adapter (100) has the first size of 7/16″ and the second size of ¼″. The first to fourth adapters (100) are configured to accommodate the drills (910) and drill bits (900) of different kinds.

The shank portion (30) of each of the first to fourth adapters (100) may be heat-treated, which may be done on small-sized shank portion (30).

Still another aspect of the invention provides a three-piece bit adapter comprising a bit-installing portion, a shank portion, and a connector portion (20′) as shown in FIG. 10.

The bit-installing portion has a hexagonal socket hole at a front end for receiving a drill tip of a first size (as in the previous embodiment) and a first connecting portion (which can be a hexagonal shank corresponding to a third connecting portion below) at a rear end as shown in FIG. 10.

The shank portion has a second connecting portion (which can be a hexagonal socket hole corresponding to a fourth connecting portion below) at a front end and a hexagonal cross-section of a second size at a rear end, which is configured to be received by a drill as shown in FIG. 10.

The connector portion (20′) has a third connecting portion (22′) corresponding to the first connecting portion at a front end and a fourth connecting portion (24′) corresponding to the second connecting portion at a rear end as shown in FIG. 10. In spite of the illustrated embodiment, each of the third and fourth connecting portions (22′, 24′) can be a hexagonal socket hole or a hexagonal shank, as long as the corresponding ones make sure their secure engagements.

The shank portion may be heat-treated.

The connector portion may be heat-treated.

The first connecting portion and the third connecting portion may comprise a male fastening device and a female fastening device.

The second connecting portion and the fourth connecting portion may comprise a male fastening device and a female fastening device.

The first and second connecting portions may be apparent in the structure and locations to be connected to the connector portion (20′) as shown in FIG. 10.

While the invention has been shown and described with reference to different embodiments thereof, it will be appreciated by those skilled in the art that variations in form, detail, compositions and operation may be made without departing from the spirit and scope of the invention as defined by the accompanying claims.

1. A bit adapter comprising:
a bit-installing portion having a hexagonal socket hole for receiving a drill tip of a first diameter;
a middle portion extended from a rear portion of the bit-installing portion by a specific length; and
a shank portion extended from a rear portion of the middle portion and having a hexagonal cross-section of a second diameter,
wherein the shank portion is configured to be received by a drill,
wherein the first diameter is different from the second diameter.

2. (canceled)

3. (canceled)

4. The bit adapter of claim 1, wherein the bit-installing portion, the middle portion, and the shank portion are formed integrally.

5. The bit adapter of claim 1, wherein the shank portion is heat-treated.

6. The bit adapter of claim 5, wherein the first diameter comprises ¼″, ⅜″, and 7/16″.

7. The bit adapter of claim 6, wherein the second diameter comprises 7/16″ and ¼″.

8. The bit adapter of claim 7, wherein the first diameter is ¼″ and the second diameter is 7/16″.

9. The bit adapter of claim 7, wherein the first diameter is ⅜″ and the second diameter is 7/16″.

10. The bit adapter of claim 7, wherein the first diameter is ⅜″ and the second diameter is ¼″.

11. The bit adapter of claim 7, wherein the first diameter is 7/16″ and the second diameter is ¼″.

12. The bit adapter of claim 1, wherein a length of the shank portion has a range from about 2½″ to about 24″.

13. The bit adapter of claim 1, wherein the drill comprises an impact drill.

14. A bit adapter set comprising:
a first bit adapter;
a second bit adapter;
a third bit adapter; and
a fourth bit adapter,
wherein each of the first to fourth bit adapter comprises:
a bit-installing portion having a hexagonal socket hole for receiving a drill tip of a first diameter;
a middle portion extended from a rear portion of the bit-installing portion by a specific length; and
a shank portion extended from a rear portion of the middle portion and having a hexagonal cross-section of a second diameter,
wherein the shank portion is configured to be received by a drill,
wherein the first bit adapter has the first diameter of ¼″ and the second diameter of 7/16″,
wherein the second bit adapter has the first diameter of ⅜″ and the second diameter of 7/16″,
wherein the third bit adapter has the first diameter of ⅜″ and the second diameter of ¼″,
wherein the fourth bit adapter has the first diameter of 7/16″ and the second diameter of ¼″,
wherein the first to fourth bit adapters are configured to accommodate the drills and drill bits of different kinds,
wherein the first diameter is different from the second diameter.

15. The bit adapter set of claim 14, wherein the shank portion of each of the first to fourth bit adapters is heat-treated.

16. A three-piece bit adapter comprising:
a bit-installing portion having a hexagonal socket hole at a front end for receiving a drill tip of a first diameter and a first connecting portion at a rear end;
a shank portion having a second connecting portion at a front end and a hexagonal cross-section of a second diameter at a rear end; and
a connector portion having a third connecting portion corresponding to the first connecting portion at a front end and a fourth connecting portion corresponding to the second connecting portion at a rear end,
wherein the shank portion is configured to be received by a drill,
wherein the first diameter is different from the second diameter.

17. The three-piece bit adapter of claim 16, wherein the shank portion is heat-treated.

18. The three-piece bit adapter of claim 17, wherein the connector portion is heat-treated.

19. The three-piece bit adapter of claim 16, wherein the first connecting portion and the third connecting portion comprise a male fastening device and a female fastening device so that the male fastening device and the female fastening device are fastened with each other, wherein the second connecting portion and the fourth connecting portion comprise a male fastening device and a female fastening device so that the male fastening device and the female fastening device are fastened with each other.

20. (canceled)
